(19) United States
(12) Patent Application Publication
(10) Pub. No.: US 2014/0164900 A1
(43) Pub. Date: Jun. 12, 2014

(54) APPENDING CONTENT WITH ANNOTATION

(71) Applicant: MICROSOFT CORPORATION, Redmond, WA (US)

(72) Inventors: Wei Zeng, Sammamish, WA (US); Ming Liu, Bellevue, WA (US); Radoslav Nickolov, Seattle, WA (US); Raman Narayanan, Seattle, WA (US)

(73) Assignee: Microsoft Corporation, Redmont, WA (US)

(21) Appl. No.: 13/711,162

(22) Filed: Dec. 11, 2012

(51) Int. Cl. G06F 17/24

(52) U.S. Cl. CPC G06F 17/241
USPC 715/230

(57) ABSTRACT

An e-reader application appends content with an annotation. A user action initiates a process to append the content with the annotation. A selection action of a portion of the content prompts an annotation menu. An annotation pane used to record the annotation is displayed in response to an activation of one of the menu commands. The annotation pane is configured based on an input type selectable by a user. The annotation is recorded after entry by the user based on the input type including text, ink, audio, and image. The annotation is displayed in an annotation view including the location of the annotation and the type of the annotation. The displayed annotation is selectable to navigate to the associated location in the content.

### BACKGROUND

Mobile computing has transformed media consumption across markets. Miniaturization across product generations has enabled more functionality to be accomplished by smaller devices. A modern smartphone has more computing capacity than a desktop computer a few years ago. Mature product processes have also enabled advances in technology to be integrated to automated production of mobile devices seamlessly. Extensive automation has led to inexpensive components. Inexpensive components have enabled manufacturing of inexpensive mobile devices providing functionality on the go.

In mobile platforms content interaction is a feature in need of significant improvement. Formatting content for presentation in an intended fashion is a significant endeavor. Scaling the formatting to multiple platforms to support mobile devices further complicates the burden of content creation. As a result, most content providers limit interactive functionality for produced content.

Publishers choose to lock interactive functionality associated with most content viewed through mobile platforms. One reason for limited interactivity is to protect the integrity of the content. Applications attempt to restore some interactivity through application provided functionality. However, applications rarely succeed in providing a consumptive flow that also enables a user to seamlessly interact with the content. In addition, interactivity features provided by mobile applications are usually resource intensive. Unnecessary consumption of resources may lead to shortened battery life and unnecessary interruption of content consumption.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to appending content with an annotation. According to some embodiments, an application of an e-reader device may detect an action associated with annotation. The content may include a variety of media including but not exclusive to text, graphic, audio, and video based media. The annotation may include a note, a highlighting, or similar actions.

A note taking pane may be displayed adjacent to the content to record the annotation. The pane may include controls to enable an input type including text, ink, audio, or image. Next, the application may record the annotation entered in the pane. The recorded annotation may be displayed in an annotation view. The annotation view may include a list of previously recorded annotations associated with the content.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example architectural diagram of appending content with an annotation in an e-reader according to some embodiments;

FIG. 2 illustrates an example of an action to append content with an annotation according to embodiments;

FIG. 3 illustrates an example annotation pane to record an annotation of content in an e-reader according to embodiments;

FIG. 4 illustrates an example annotation view displaying recorded annotation associated with the content according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process appending content with an annotation in an e-reader according to embodiments.

### DETAILED DESCRIPTION

As briefly described above, content may be appended with an annotation. An e-reader application may display a note taking pane to record an annotation in response to an action to append the content. The annotation may be recorded in the pane and displayed in an annotation view. An annotation pane may be used for both entering the annotation and viewing a previously recorded annotation. An annotation view may provide all annotations shown as a brief list for a user to locate an annotation quickly. A user can use the annotation view to quickly locate an annotation. When the user needs to view the annotation again, the annotation pane may be presented for all the details.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for appending content with an annotation. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

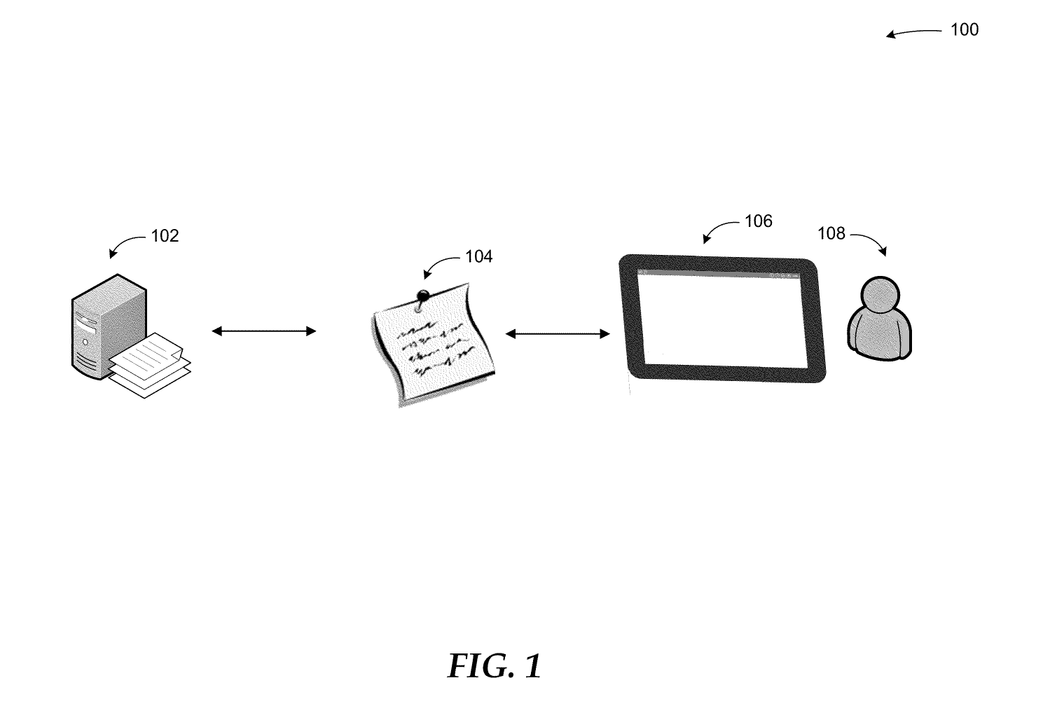

FIG. 1 illustrates an example architectural diagram of appending content with an annotation in an e-reader according to embodiments. The components and environments shown in diagram 100 are for illustration purposes. Embodiments may be implemented in various local, networked, cloud-based and similar computing environments employing a variety of computing devices and systems, hardware and software.

An “e-reader” device such as a tablet 106 may host an application providing content to a user 108. Such an application may be called an e-reader application, which may be a locally installed and executed application receiving content (e.g., e-books, documents, etc.) through wired or wireless networks. The e-reader application may also be a hosted service provided by one or more servers and accessed by the user 108 through the e-reader device (e.g., tablet 106). Content may be any type of consumable data including but not exclusive to text, audio, video, graphic, etc. Content may also include media combinations presented in a standardized format (e.g., ePub, HTML, XHTML, etc.) Content may be provided by a content server 102 hosting the content for consumption by services and devices.

An application according to embodiments may be a standalone application executed in a tablet device 106. A standalone application may detect an action to append content with an annotation 104. The action may be a user action selecting a portion of the content. The selection may prompt an annotation menu. The annotation menu may provide commands to select an annotation type.

An annotation pane may be displayed in response to an activation of one of the commands. The annotation 104 may be recorded upon entry into the annotation pane. The recorded annotation 104 may be displayed in an annotation view.

Embodiments are not limited to implementation in a tablet 106. An application according to embodiments may append an annotation to content in other platforms. A user may append the annotation to the content in any device capable of displaying the content. In addition to a touch-enabled device content appending may be accomplished through other input mechanisms such as optical gesture capture, a gyroscopic input device, a mouse, a keyboard, an eye-tracking input, and comparable software and/or hardware based technologies.

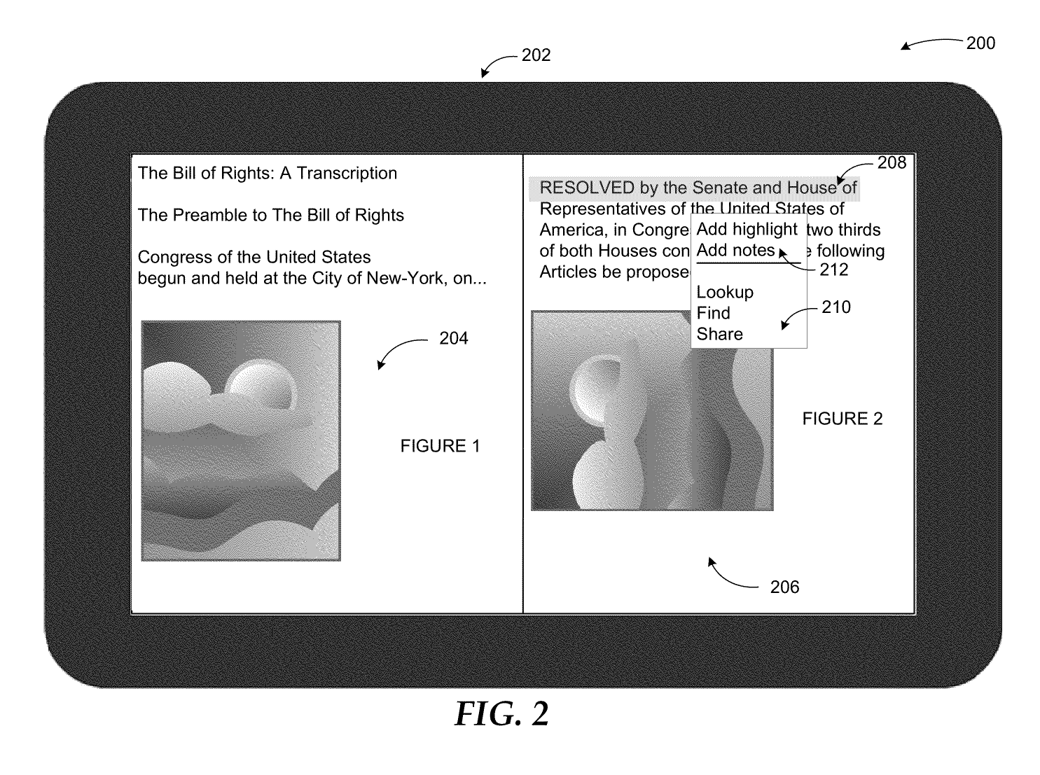

FIG. 2 illustrates an example of an action to append content with an annotation according to embodiments. Diagram 200 displays an application of an e-reader device prompting an annotation menu 210 in response to an action on an e-reader device 202 (e.g., a tablet).

The e-reader device 202 may display content 204 and 206. Content may be partitioned based on display parameters of the e-reader application. In an example scenario, the application may partition an e-book to pages and display two pages 204 and 206 adjoined horizontally in a tablet when viewed horizontally. Alternatively, the content may be displayed one page at a time when viewing the tablet in a vertical orientation.

The detected action may be a selection 208. The selection 208 may initiate the annotation menu 210. The annotation menu 210 may have commands 212 to select a type of annotation to record. The type of annotation may include a highlighting or a note in some examples. A highlighting may be a shading applied to a portion of the content. A note may include text, ink, audio, or image used to annotate a portion of the displayed content. Alternatively, the note may be used as an annotation for a partition of the content such as a page, a table, a column, etc.

The action may be detected as a user action including a touch, a pen, a keyboard, a mouse, a gesture, and other based input. In an example scenario, a selection of a portion of the content through a touch, a keyboard, or a mouse input may be evaluated for launching the annotation menu 210.

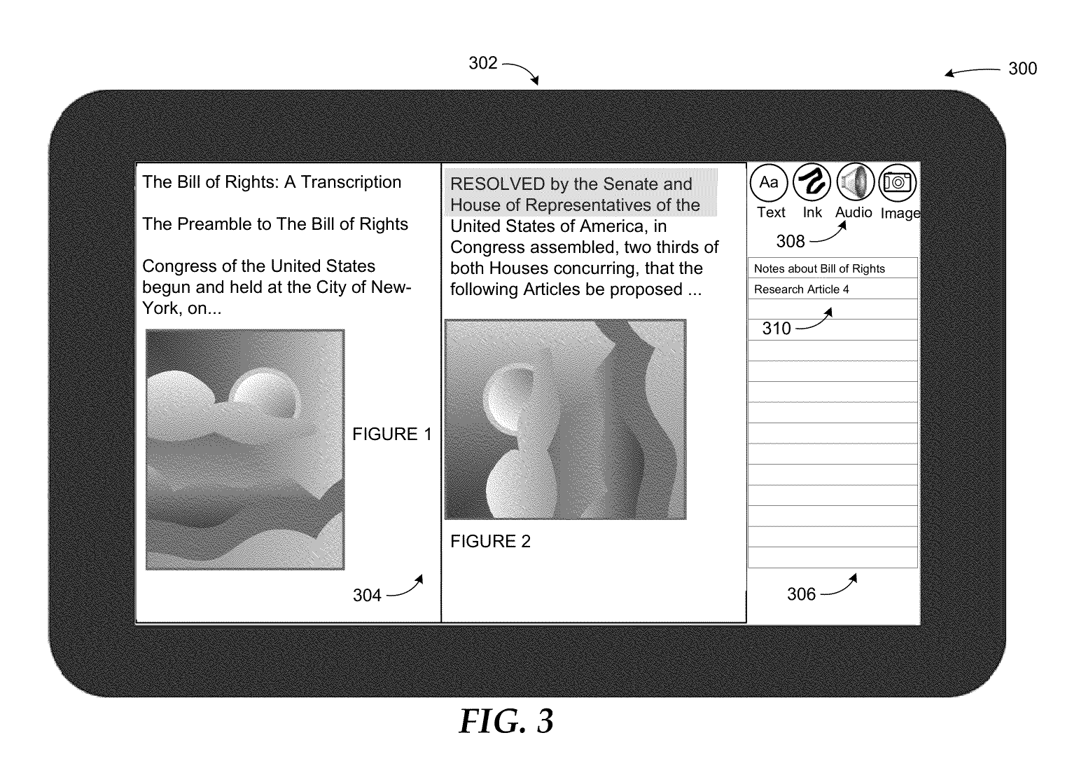

FIG. 3 illustrates an example annotation pane to record an annotation of content according to embodiments. Diagram 300 displays annotation pane 306 used to record the annotation 310.

An e-reader application executed in device 302 may display content 304. Content 304 may be partitioned according to application and device settings. The displayed content may be formatted according to a view orientation as described above.

An annotation pane 306 may be displayed adjacent to the content to record the annotation. The annotation pane may include controls 308 to activate an input type. The controls may include text, ink, audio, and image based input. Text control may configure the pane 306 to present a text entry box to record the annotation. A user may type the annotation through an on screen or a physical keyboard.

An ink control may activate recording of a point base input device, which may be pen/stylus or mouse annotation. Pen input may be captured and stored as an annotation. Hand writing analysis may be performed to recognize text in the annotation. Recognized text may be stored in the annotation. In addition, a pen input on a selection of a portion of the content may be used to highlight the portion. The highlighting may be captured as a highlighting type annotation. The application may display additional controls during highlighting capture to define attributes of the annotation including highlighting color, etc.

In some embodiments, an audio control may activate recording an audio input based annotation. Audio component of the device 302 may be enabled to record audio file. The audio file may be recorded as the annotation through the audio component of the device 302. Alternatively, an audio file prompt may be displayed to insert an audio file as the annotation. Speech-to-text analysis may be performed on the recorded annotation. Recognized text may be stored in the annotation.

An image control may also be used to activate recording an image based annotation. Camera component of the device 302 may be enabled to record the image. Alternatively, an image file prompt may be enabled to insert an image file as the annotation. Optical character recognition may be performed on the image file to recognize text within the image. Recognized text may be stored in the annotation.

The pane 306 may be configured dynamically according to the input type selection through one of the controls 308. In an example scenario, selecting text based annotation may display a lined text box for entry of the annotation. Selecting an ink based input type may display a blank pane for entry of the pen input. Selecting an audio or image based input type may initiate components associated with the selected input to record the annotation.

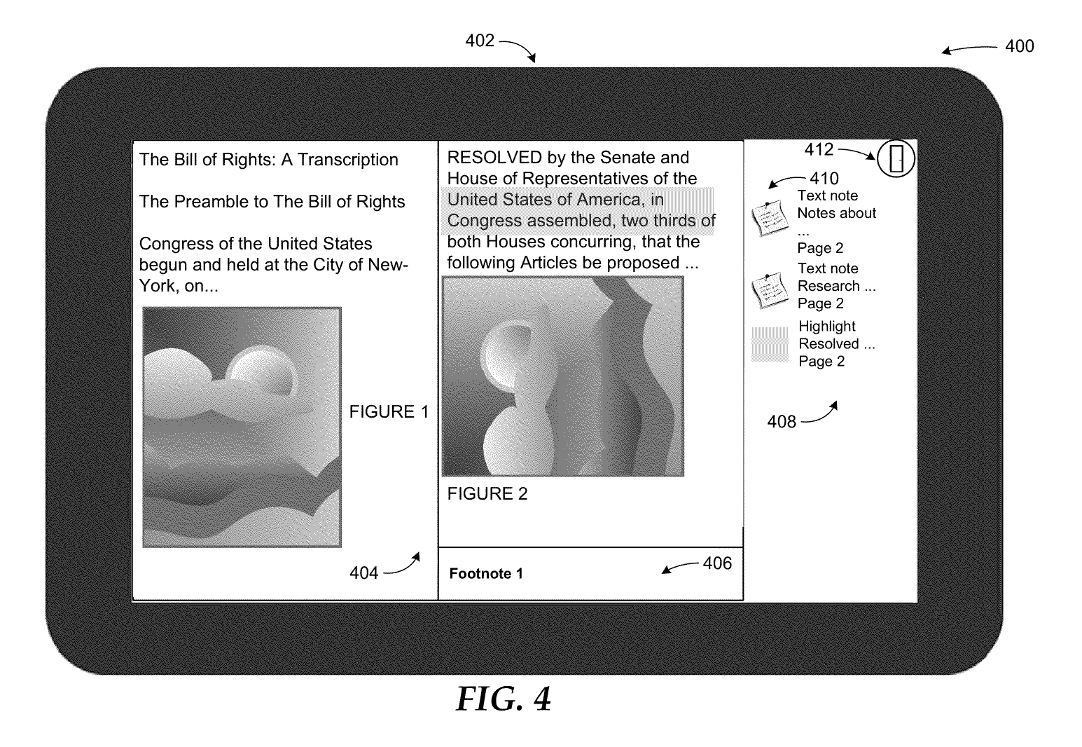

FIG. 4 illustrates an example annotation view displaying recorded annotation associated with the content according to embodiments. Diagram 400 displays an e-reader device 402 providing an annotation view 408.

The e-reader device 402 may display content 404 according to device or application settings as described above. The e-reader application, according to embodiments, may also display notes used during content production (authoring) in footnote 406. The footnote 406 may be dynamically generated and may be hidden according to a user or a system preference.

The annotation view 408 may have an exit control 412 to minimize, hide, or close the annotation view. The annotation may be recorded with type and location information. The location information may refer to a location in the content associated with the annotation. The location may refer to a portion of the content such as a selection or a partition such as a page, a table, a column, etc. The annotation may also be recorded with the annotation type. The annotation type may be a note or a highlighting.

The annotation view 408 may display annotations associated with the content in a list 410. The annotation may be displayed with identifier information including annotation type (e.g., note or highlighting). The annotation view may also display a graphic to represent the annotation type, text of the annotation, and location within the content associated with the annotation. The displayed annotation may be selectable. In response to a selection of one of the displayed annotations, the application may navigate to the location within the content referred by the annotation. Furthermore, in response to the selection, a prompt displaying the annotation may be overlaid on top of the location within the content. If the annotation type is highlighting, the portion of the content associated with the annotation may be highlighted in response to the selection.

The example scenarios and schemas in FIG. 2 through 4 are shown with specific components, data types, and configurations. Embodiments are not limited to systems according to these example configurations. Appending content with an annotation in an e-reader may be implemented in configurations employing fewer or additional components in applications and user interfaces. Furthermore, the example schema and components shown in FIG. 2 through 4 and their subcomponents may be implemented in a similar manner with other values using the principles described herein.

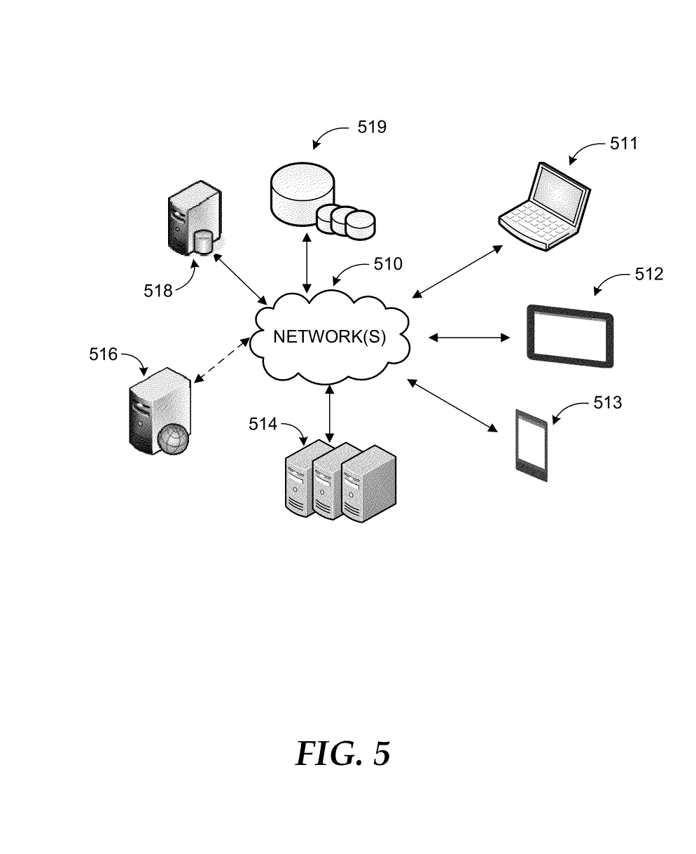

FIG. 5 is a networked environment, where a system according to embodiments may be implemented. Local and remote resources may be provided by one or more servers 514 or a single server (e.g. web server) 516 such as a hosted service. An application may execute on individual computing devices such as a smart phone 513, a tablet device 512, or a laptop computer 511 (‘client devices’) and communicate with a content resource through network(s) 510.

As discussed above, an e-reader application may append content with an annotation. The application may display an annotation pane to record the annotation. The recorded annotation may be displayed in an annotation view within an e-reader device. Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to append content with an annotation in an e-reader. Furthermore, the networked environments discussed in FIG. 5 are for illustration purposes only. Embodiments are not limited to the example applications, modules, or processes.

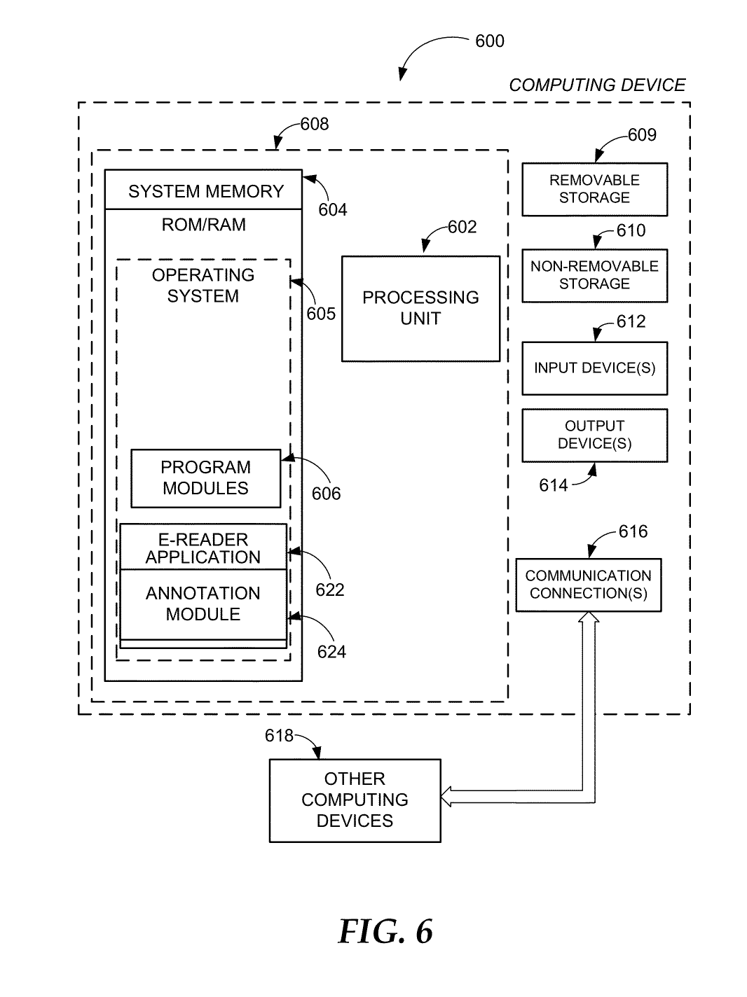

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® and WINDOWS PHONE® operating systems from MICROSOFT CORPORATION of Redmond, Wash. The system memory 604 may also include one or more software applications such as program modules 606, an e-reader application 622, and an annotation module 624.

An e-reader application 622 may detect an action to append content with an annotation. The action may include a selection of a portion of the content. The application 622 may display an annotation pane to record the annotation in response to the selection. The annotation module 624 may record the annotation entered in the annotation pane. The annotation module 624 may further process the annotation to recognize text embedded in the annotation. The annotation may be displayed in an annotation view by the application 622. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

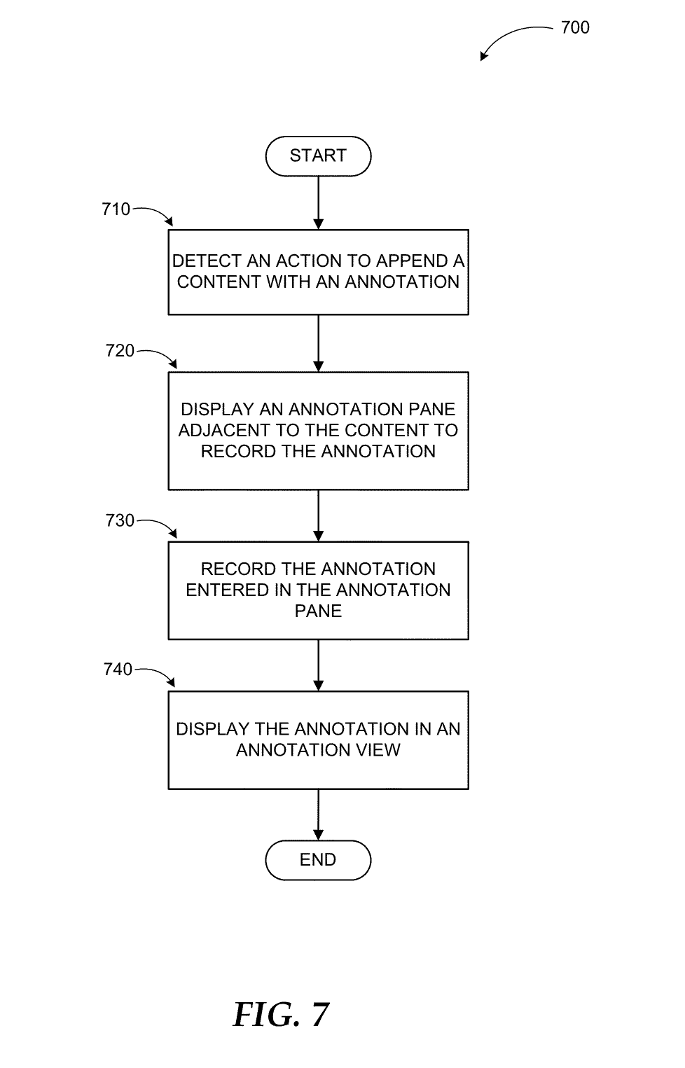

FIG. 7 illustrates a logic flow diagram for a process appending content with an annotation in an e-reader according to embodiments. Process 700 may be implemented by an e-reader application in some examples.

Process 700 may begin with operation 710 where the e-reader application may detect an action to append content with an annotation. The action may include a selection of a portion of the content. The selection may launch an annotation menu for selecting an annotation type including a note or a highlighting. At operation 720, an annotation pane may be displayed adjacent to the content to record the annotation. The annotation pane may be configured according to input type specified through an input type control. Input types include text, ink, audio, or image. Next, the application may record the annotation entered in the annotation pane at operation 730. The recorded annotation may be processed for embedded text and tagged with identifier information such as location within the content associated with the annotation and the annotation type. The annotation may be displayed in an annotation view at operation 740. Alternatively, the recorded annotation may also be displayed in the annotation pane.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Appending content with an annotation, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for appending e-reader content with an annotation, the method comprising:
detecting an action to append the content with the annotation;
displaying an annotation pane adjacent to the content to record the annotation;
recording the annotation entered into the annotation pane; and
displaying the annotation in one of an annotation view and the annotation pane.

2. The method of claim 1, further comprising:
evaluating the action as a selection of a portion of the content.

3. The method of claim 1, further comprising:
displaying an annotation menu including one or more commands to select an annotation type including: a note and a highlighting, in response to the action; and
detecting an activation of one of the commands to display the annotation pane.

4. The method of claim 1, further comprising:
displaying input type controls within the annotation pane including at least one of: a text input, an ink input, an audio input, and an image input type control to enter the annotation into the annotation pane.

5. The method of claim 1, further comprising:
detecting an activation of an input type control to enter the annotation into the annotation pane.

6. The method of claim 5, further comprising:
configuring the annotation pane to display a text box for a text input based entry of the annotation.

7. The method of claim 5, further comprising:
configuring the annotation pane to display a blank pane for an ink input based entry of the annotation.

8. The method of claim 5, further comprising:
configuring the annotation pane to display a file prompt for insertion of a file associated with one of: an audio input and an image input, as the annotation.

9. The method of claim 1, further comprising:
applying the annotation to at least one of: a portion of the content including a selection and a partition of the content including a page, a column, and a table.

10. The method of claim 1, further comprising:
detecting the action as a user action including at least one of: a touch, a pen, a keyboard, a mouse, and a gesture based input.

11. A computing device for appending content with an annotation in an e-reader, the computing device comprising:
a memory configured to store instructions; and
a processor coupled to the memory, the processor executing an application in conjunction with the instructions stored in the memory, wherein the application is configured to:
detect an action to append the content with the annotation;
display an annotation menu including one or more commands to select an annotation type including: a note and a highlighting, in response to the action;
detect an activation of one of the commands;
display an annotation pane adjacent to the content to record the annotation in response to the activation;
detect an input type selection to enter the annotation into the annotation pane;
record the annotation entered into the annotation pane; and
display the annotation in one of an annotation view and the annotation pane.

12. The computing device of claim 11, wherein the application is further configured to:
capture a pen input as the annotation;
perform hand writing analysis to recognize a text in the annotation; and
store the recognized text in the annotation.

13. The computing device of claim 11, wherein the application is further configured to:
record an audio file through an audio component of the e-reader as the annotation;
perform speech-to-text analysis on the annotation; and
store a recognized text in the annotation.

14. The computing device of claim 11, wherein the application is further configured to:
record an image through a camera component of the e-reader as the annotation;
perform optical character recognition on the annotation; and
store a recognized text in the annotation.

15. The computing device of claim 11, wherein the application is further configured to:
enable one or more of insertion of a note into an original content flow, insertion of a note page in a book content flow, and a creation of a flowing note alongside a corresponding portion of the content.

16. The computing device of claim 11, wherein the application is further configured to:
dynamically generate a footnote to display another note associated with the content generated during content creation; and
dynamically hide the footnote based on at least one of: a user and a system preference.

17. A computer-readable memory device with instructions stored thereon for appending content with an annotation, the instructions comprising:
detecting an action to append the content with the annotation;
evaluating the action as a selection of a portion of the content;
displaying an annotation menu including one or more commands to select an annotation type including: a note and a highlighting, in response to the selection;
detecting an activation of one of the commands;
displaying an annotation pane adjacent to the content to record the annotation in response to the activation;
detecting an input type selection to enter the annotation into the annotation pane;
recording the annotation entered into the annotation pane; and
displaying the annotation in an annotation view.

18. The computer-readable memory device of claim 17, wherein the instructions further comprise:
recording the annotation with a location within the content associated with the annotation and the annotation type.

19. The computer-readable memory device of claim 18, wherein the instructions further comprise:
displaying a graphic representing the annotation type, the annotation, and the location in an annotations list within the annotation view.

20. The computer-readable memory device of claim 19, wherein the instructions further comprise:
detecting another activation of the annotation displayed in the annotations list;
navigating to the location within the content associated with the annotation; and
displaying the annotation in a prompt overlaying the location.
